(19) United States
(12) Patent Application Publication
(10) Pub. No.: US 2023/0182337 A1
(43) Pub. Date: Jun. 15, 2023

(54) Axe Head and Axe for Throwing

(71) Applicant: Calculated Survival LLC, Brookfield, CT (US)

(72) Inventors: Luke Stephen Huizinga, Brookfield, CT (US); Erik Thor Kukk, Brookfield, CT (US)

(21) Appl. No.: 18/155,718

(22) Filed: Jan. 17, 2023

Related U.S. Application Data
(63) Continuation-in-part of application No. 29/864,613, filed on Jun. 7, 2022.
Application No. 29/864,613 is a continuation-in-part of application No. 29/790,719, filed on Dec. 10, 2021.
(60) Provisional application No. 63/266,831, filed on Jan. 14, 2022.

(51) Int. Cl. B26B 23/00

(52) U.S. Cl. CPC B26B 23/00

(57) ABSTRACT

The present disclosure describes various articles of manufacture configured for use as throwing axes and hatchets with, in some embodiments, concave blade designs that improve the ability of a thrown axe to remain embedded in a target.

### CROSS-REFERENCE TO RELATED APPLICATIONS

The present application claims the benefit of priority of U.S. Provisional patent application No. 63/266,831 filed Jan. 14, 2022, entitled “Axe Head and Axe for Throwing,” which is incorporated by reference in the present application.

The present application claims the benefit of priority of U.S. Design patent application No. 29/790,719 filed Dec. 10, 2021, entitled “Throwing Hatchet,” which is incorporated by reference in the present application.

The present application claims the benefit of priority of U.S. Design patent application No. 29/864,613 filed Jun. 7, 2022, entitled “Throwing Hatchet,” which is incorporated by reference in the present application.

### FIELD OF THE INVENTION

The present invention relates to throwing axes and hatchets.

### BACKGROUND

The throwing of axes, hatchets, and tomahawks (referred to collectively herein as “throwing axes”) is a recreational activity growing in popularity. Despite the recreational appeal of throwing axes, axes used in the prior art for throwing have tended to be of traditional designs primarily suitable for chopping. Accordingly, prior art axes are not optimized for either throwing or penetrating and sticking into targets.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is an elevational view of a throwing axe according to an embodiment of the present invention;

FIG. 2 is a perspective view of a throwing axe according to an embodiment of the present invention;

FIG. 3 is an elevational view of a throwing axe according to an embodiment of the present invention;

FIG. 4 is an elevational view of a throwing axe according to an embodiment of the present invention;

FIG. 5 is an elevational view of a throwing axe according to an embodiment of the present invention; and

FIG. 6 is a perspective view of a throwing axe according to an embodiment of the present invention.

### DETAILED DESCRIPTION

The inventors for this application have recognized that users who have an interest in throwing axes and hatchets may find it advantageous to have a throwing axe that better penetrates and sticks or remains embedded in a target.

The present invention, in accordance with some embodiments, is a throwing axe comprised of a head and a handle. In one or more embodiments, the head has fore, mid, and aft portions. According to some embodiments, the head has only a fore portion and a mid portion for affixing the head to the handle. In some embodiments providing a double-bladed configuration, the head has two fore portions, opposite one another, and a mid portion.

According to some embodiments, the fore portion has two sides, forming a blade-like extension from the mid portion. The fore portion has a piercing or embedding means that comprises a concavely arcuate striking face. The striking face comprises a piercing edge and preferably at least one axe tip portion, each at least one axe tip portion being a respective end of the concave arc of the concavely arcuate striking face, the at least one tip portion adapted to facilitate embedding of the head in a target object. The head is configured to receive a handle, the handle being used to throw the head toward a target object. The throwing axe typically rotates vertically when thrown. On impact, preferably the at least one tip portion of the striking face leads and penetrates into—and preferably remains embedded in on impact—the target object. In some embodiments, the aft portion may comprise a pick that may sometimes penetrate into the target object as the head rotates (instead of or in addition to a tip portion of the striking face).

According to some embodiments, the entirety of the striking face of a fore portion is configured as a concave arc; in other embodiments, only a portion of the striking face is configured in a concave arc. According to some embodiments, the concave arc of a striking face is not angularly uniform but is substantially concave along the entirety of the striking face; in other embodiments, the concave arc is uniform (i.e., as if an arc of a singular circle).

According to some embodiments, a head comprising (i) a striking face having at least an upper axe tip portion and (ii) an aft portion comprising a rear axe tip portion or pick portion, comprises a second piercing or embedding means along the top surface of the head. For example, the second piercing means may comprise a second, concavely arcuate striking face along the top surface of the head, defined by an axe tip portion of the pick and an axe tip portion at the top of the concave arc of the striking face. The top surface may, but does not necessarily, comprise an edge along its entire length; in some embodiments, the top and/or rear axe tip portions may comprise a respective edge.

According to some embodiments, a throwing axe comprises a handle and a head comprising: a striking face, the striking face having a top axe tip portion and a bottom axe tip portion, the striking face further having an edge defined in a substantially concave arc between the top axe tip portion and the bottom axe tip portion.

In accordance with various embodiments of the present invention, a concave profile of a striking face of an axe head increases the likelihood that an axe tip portion of the axe head will make first contact with a target object (e.g., when thrown or otherwise operated by a user or machine to engage the target object), thereby increasing the likelihood that the axe head will penetrate and stick in the target object.

According to some embodiments, an axe head for a throwing axe comprises a pick (e.g., in an aft portion of the axe head) extending away from the axe face (e.g., at a fore portion of the axe head).

Throughout the description and unless otherwise specified, the terms used may include and/or encompass the example meanings provided. These terms and illustrative example meanings are provided to clarify the language selected to describe embodiments both in the specification and in the appended claims, and accordingly, are not intended to be limiting.

A “throwing axe” (or “throwing hatchet”) may refer in this disclosure to an axe-like tool, such as an axe, hatchet, tomahawk, or the like, with an axe blade or axe head attached to a handle and configured to be and/or intended to be thrown (e.g., by a human user, by a machine) at a target. The terms “axe” and “hatchet” are not intended to be limiting and may be used interchangeably with respect to various embodiments described in this disclosure.

According to some embodiments, an axe head for a throwing axe comprises a blade (or bit) having a concave edge or profile that tapers to a tip (also referred to as a toe) for embedding in a target.

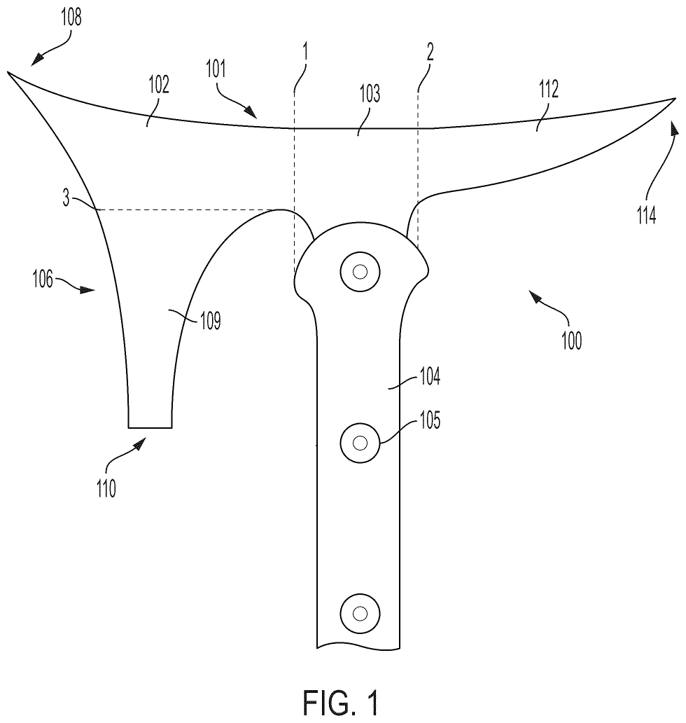

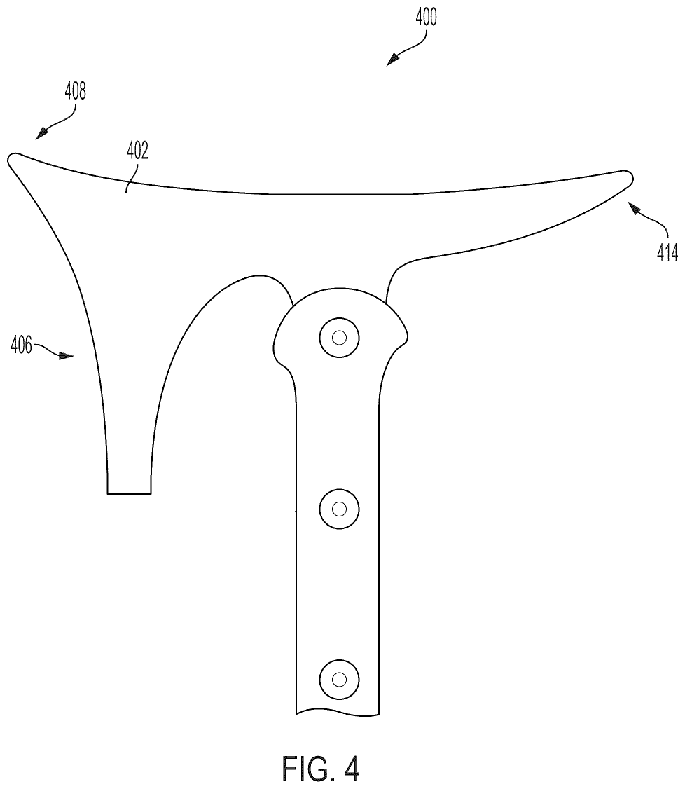

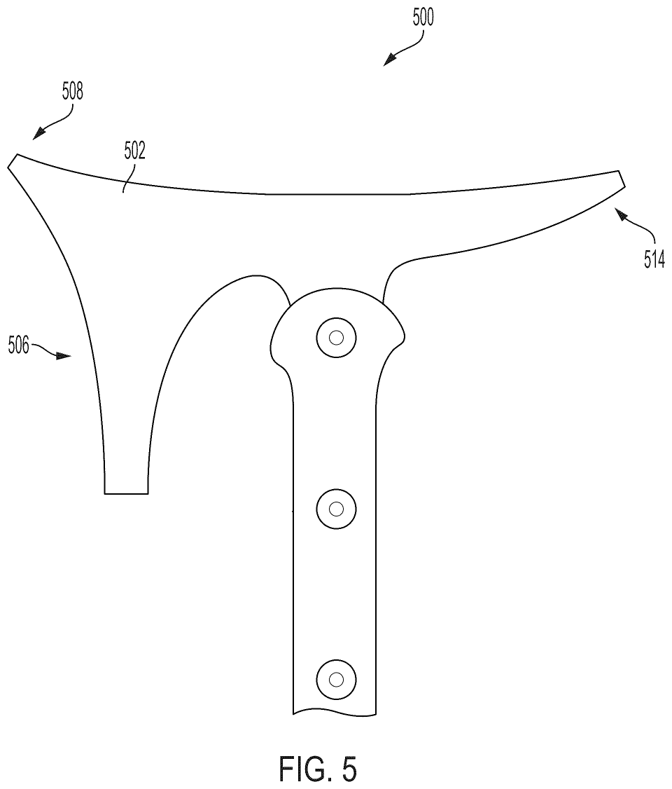

Various shapes of tip may be used in accordance with different embodiments as deemed desirable for a particular implementation. For example, the toe may terminate at a sharp point (see, e.g., FIG. 1), may be rounded (see, e.g., FIG. 4), may terminate at a squared or flat surface (see, e.g., FIG. 5), may be a chisel tip, etc. Different materials may be more suitable for different types of tips. For example, high-quality steel may be more suitable for a sharp point tip that may experience more stress during use; in another example, lower-quality steel may be suitable for making an axe head having a rounded tip.

According to some embodiments, an axe head for a throwing axe comprises a blade having a double-concave profile (a front or lower concave edge and a top or upper concave edge) that tapers to a tip. In other embodiments, the top edge of the axe head extending toward the toe for embedding in a target may be straight or flat or may have a concave edge that curves downward to the toe.

According to some embodiments, the axe head may further comprise a beard (also referred to as a hook).

According to some embodiments, an axe head for a throwing axe comprises (1) a blade with a concave profile that tapers to a tip for embedding in a target and (2) a pick (e.g., on the opposite side of the axe head from the tip). In one embodiment, the pick comprises a first (upper) edge that is concave and a second (lower) edge that is convex. In one or more embodiments, the pick tapers up (relative to a top surface of the axe head) to a tip for embedding in a target. The tip of the pick may comprise any of various types of points, including those described above and illustrated in FIGS. 1, 4, and 5.

In some embodiments, an axe head does not include a pick opposite the blade side of the axe head. In one embodiment, the axe head may include a poll, hammer, or other tool implement opposite the blade (on the back side of the axe head); other types of tool implements may be included as deemed appropriate for a desired implementation.

In some embodiments, an axe head comprises two blades, one on either side of the axe head (a “double axe”). One or both of the blades may have a single- or double-concave profile as described in this disclosure. In one embodiment, a first blade may have the double-concave profile with a tip configured for embedding in a target when thrown (optimized for throwing), and the second blade may be configured with a forward edge optimized for chopping.

According to some embodiments, an axe head for a throwing axe comprises a blade having a single- or double-concave profile that tapers to a first tip for embedding in a target on one side and a second tip on the opposite side of the axe head from the first tip. In one embodiment, the second tip is embodied as a pick.

According to some embodiments, a throwing axe comprises (1) a blade having a single- or double-concave profile, a beard or hook, and a tapered tip configured to embed in a target; and (2) a handle. The throwing axe may further comprise a pick (or other type of implement) opposite the blade. Various examples of picks and pick shapes are described above. In one embodiment, the blade and the pick are embodied in a unitary axe head, as described above, that is attached to the handle; in other embodiments, the pick and the blade may be attached separately to the handle.

It will be readily understood that the axe heads, blades, and picks described in this disclosure may be made of any number and variety of materials suitable for the desired durability and target type, including but not limited to steel (e.g., high carbon steel, lower quality steel), stone, titanium, plastic, hardened rubber, wood, and/or carbon fiber. One or more of the axe heads described in this disclosure or otherwise contemplated by the scope of various embodiments of the present invention may be made from a high carbon steel. Example of such a steel include 1055, 1095, and SK-5.

According to some embodiments, an axe head may be formed of a flat blade stock of generally uniform thickness. In one or more embodiments, an axe head may have a sharpened cutting edge (e.g., a striking edge may comprise a sharpened cutting edge).

Several embodiments described in this disclosure provide for an axe head configured to be affixed to a handle by fitting the axe head at least partially within the handle, such as by bolting two halves of a handle together with a portion of the axe head between them (see, e.g., FIG. 1). Other ways of affixing an axe head to a handle will be readily understood by those skilled in the art and are contemplated in accordance with some embodiments of the present invention. In one or more embodiments, an axe head may define a hole therethrough for receiving the handle. The axe head may be slid, for example, from the grasping end of the handle toward the opposite end of the handle, with the shape of the handle (e.g., being wider than the hole) or some other obstacle or connecting means (e.g., bolts and nuts) for resisting and/or securing the head from sliding off the opposite end of the handle. According to some embodiments, an axe head and handle may be forged, cast, or printed into one continuous piece.

Handles, as it will be readily understood, may be constructed of any one or more of various types of materials, including but not limited to plastic, wood (e.g., hickory, ash, or oak), metal, carbon fiber, rubber, and/or any sufficiently rigid polymer, such as fiberglass, polypropylene, nylon, and composites of nylon and fiberglass.

Referring now to FIG. 1, a diagram of an example throwing axe 100 according to some embodiments is shown. The throwing axe 100 comprises a handle 104 connected to an axe head 101. The axe head 101 includes three general portions: a fore portion defined in the view of FIG. 1 as the portion to the left of the line 1; a mid portion defined as the portion between lines 1 and 2; and an aft portion defined as the portion to the right of line 2. The fore portion of the axe head further comprises a beard portion 109 generally defined below the horizontal line 3, which corresponds to the apex of the concave arc terminating in the mid portion.

As depicted in FIG. 1, the fore portion includes a blade 102 with a striking face 106 having a concave profile and that tapers to an upper axe tip portion 108 for embedding in a target. According to the embodiment depicted in FIG. 1, the striking face 106 is arcuate and concave relative to the axe tip portion 108 and the lower axe tip portion no of the beard 109. In other words, the axe tip portion 108 and the lower axe tip portion 110 lead the axe head 101—relative to the central portion of the striking face 106—and thus are likely to be the first portions of the striking face 106 to make contact with a target when the throwing axe 100 is used (such as by a user throwing or wielding the throwing axe 100 by hand to strike the target).

As depicted in FIG. 1, in accordance with some embodiments, the throwing axe 100 further comprises a handle portion 103 of the axe head 101 for joining the axe head 101 to the handle 104. Various means of affixing a handle to an axe head will be readily understood by those skilled in the art; FIG. 1 depicts but one example of the handle 104 being secured to the handle portion 103 of the axe head 101 using one or more nuts and bolts 105. For example, the handle 104 may comprise multiple portions (e.g., a right handle side and a left handle side) that are secured through corresponding holes in a lower portion (not shown) of the handle portion 103, the lower portion extending at least the length of the indicated lowermost bolt, and wherein the handle sides are affixed to one another using nuts and bolts 105.

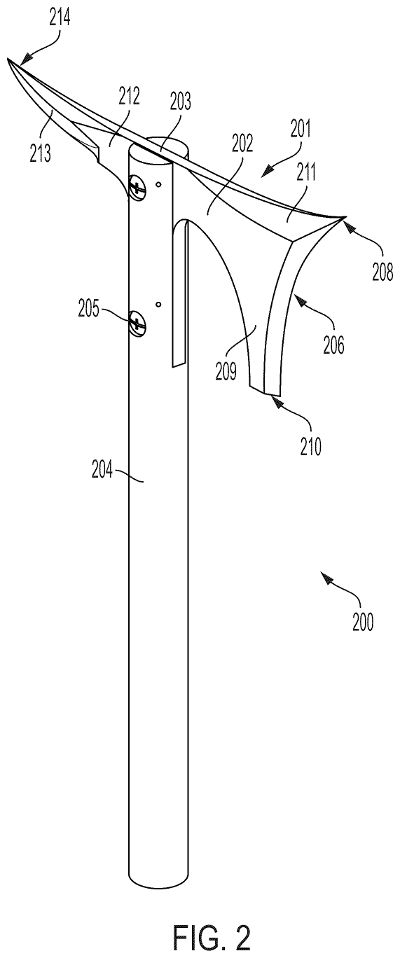

As depicted in FIG. 1, in accordance with some embodiments, the aft portion of the throwing axe 100 comprises a pick 112. In one embodiment, as depicted in FIG. 1, the pick 112 comprises a first (upper) edge that is concave and a second (lower) edge that is convex. In some alternative embodiments, one or more of the upper edge and the lower edge of the pick 112 may be concave. As shown in FIG. 1, in one or more embodiments, the pick 112 tapers up (relative to a top surface of the axe head 101) to a pick tip portion 114 (e.g., for embedding in a target). As depicted in FIG. 1, some embodiments of a throwing axe may comprise a second striking face, such as is defined in FIG. 1 by the axe tip portion 108 and the pick tip portion 112, that may be advantageous for embedding the axe head 101 in a target. Referring now to FIG. 2, a perspective view of an example throwing axe 200 according to some embodiments is shown. The throwing axe 200 comprises a handle 204 connected to an axe head 201, the axe head 201 comprising a blade portion 202, a handle portion 203, and a pick portion 212 terminating in a pick tip portion 214.

As depicted in FIG. 2, the blade portion 202 comprises a striking face 206 and a beard 209. The striking face 206 comprises an upper axe tip portion 208 and a lower axe tip portion 210 (at the bottom of the beard 209), and the striking face 206 has a substantially concave configuration between the two axe tip portions.

As depicted in FIG. 2, the blade portion 202 further comprises at least one sharpened edge 211 along the upper surface from the axe tip portion 208 toward the handle portion 203 and/or along the striking face 206. Also, according to some embodiments, the pick 212 may have a sharpened edge 213 along the upper and/or lower surface of the pick 212.

As depicted in FIG. 2, in accordance with some embodiments the handle 204 may be affixed to the axe head 201 by inserting the axe head 201 in a corresponding slot of the handle 204 and securing the axe head 201 in place using one or more fasteners 205 (e.g., nuts and bolts).

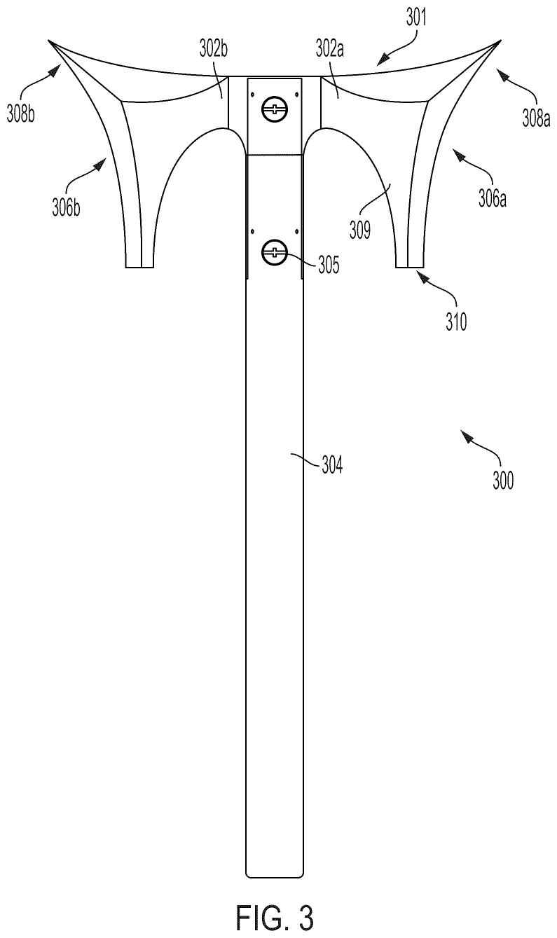

Referring now to FIG. 3, a diagram of an example double-bladed throwing axe 300 according to some embodiments is shown. The throwing axe 300 comprises a handle 304 connected to a double-sided axe head 301, the double-sided axe head 301 comprising two opposite blade portions 302a, 302b. The double-bladed throwing axe 300, like some other embodiments contemplated by the present disclosure, does not comprise a pick. The axe head 301 may be manufactured as a unitary piece having integrated two blade portions 302a, 302b and/or the blade portions may be separate (and/or separable) from one another and connected individually to the handle 304 to form the axe head 301, as desired for a particular implementation.

Each blade portion 302a, 302b comprises a respective striking face 306a, 306b having at least one respective axe tip portion 308a, 308b. As shown in FIG. 3, each striking face may have a substantially concave configuration between its respective upper axe tip portion and respective lower end. For example, striking face 306a is concavely arcuate between the upper axe tip portion 308a and the lower axe tip portion 310 of beard 309.

As depicted in FIG. 3, in accordance with some embodiments the handle 304 may be affixed to the axe head 301 by inserting the axe head 301 in a corresponding slot of the handle 304 and securing the axe head 301 in place using one or more fasteners 305 (e.g., nuts and bolts).

Referring now to FIGS. 4 and 5, some examples of alternative tips for axe tip portions are described. The example throwing axe 400 of FIG. 4 comprises a blade portion 402 having a striking face 406 (with a substantially concave profile) and an axe tip portion 408 having a rounded tip. The pick tip portion 414 is similarly depicted with a rounded tip. While depicted as having substantially pointed corners, the lower part of the beard of blade portion 402 could similarly be rounded (or of any other desired configuration or combination of shapes). The example throwing axe 500 of FIG. 5 comprises a blade portion 502 having a striking face 506 (with a substantially concave profile) and an axe tip portion 508 having a flat tip. The pick tip portion 514 is similarly depicted with a flat tip.

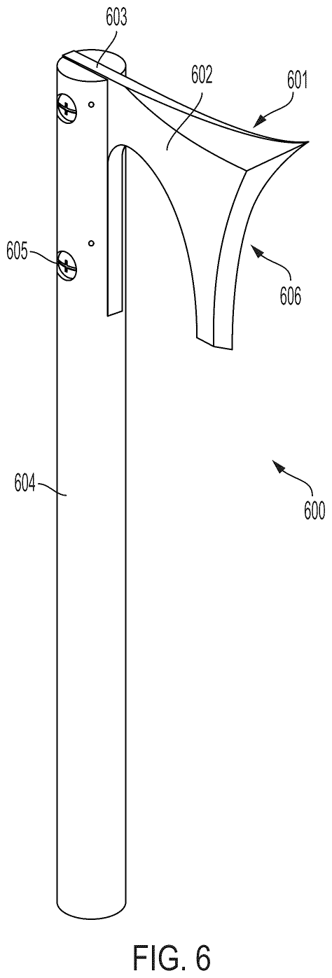

Referring now to FIG. 6, a perspective view of an example throwing axe 600 according to some embodiments is shown. The throwing axe 600 comprises a handle 604 connected to an axe head 601, the axe head 201 comprising a blade portion 602 and a handle portion 603. Unlike throwing axe 100 (FIG. 1) and throwing axe 200 (FIG. 2), the throwing axe 600 does not comprise an aft portion—in particular, it does not include a portion or tool component that extends on the other side of handle 604 from the blade portion 202. According to some embodiments, a throwing axe may comprise a small aft portion, such as an aft portion having a blunt surface (e.g., extending 0.5 to 1 inches from the handle). Such a reduced aft portion may be suitable, for example, for providing balance to the throwing axe that improves its suitability for throwing.

Additional examples of throwing axe heads and corresponding throwing axes having at least one substantially concave striking face and/or blade portion are described in the specifications and drawings of U.S. Provisional Patent Application No. 63/266,831, U.S. Design patent application No. 29/790,719, and U.S. Design patent application No. 29/864,613, each of which is incorporated by reference in the present application.

### Interpretation

Numerous embodiments are described in this patent application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention may be practiced with various modifications and alterations, such as structural, logical, software, and/or electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features that must be present in all embodiments.

Neither the Title (as may be set forth at the beginning of the first page of this disclosure) nor the Abstract (as may be set forth at the end of this disclosure) is to be taken as limiting in any way the scope of the disclosed invention(s).

Throughout the description and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car, and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

As used in this disclosure, a “user” may generally refer to any individual and/or entity that operates a device.

When a single device or article is described in this disclosure, more than one device or article (whether or not they cooperate) may alternatively be used in place of the single device or article that is described. Accordingly, the functionality that is described as being possessed by a device may alternatively be possessed by more than one device or article (whether or not they cooperate). Where more than one device or article is described in this disclosure (whether or not they cooperate), a single device or article may alternatively be used in place of the more than one device or article that is described. Accordingly, functionality that is described as being possessed by more than one device or article may alternatively be possessed by a single device or article. The functionality and/or the features of a single device that is described may be alternatively embodied by one or more other devices that are described but are not explicitly described as having such functionality and/or features. Thus, other embodiments need not include the described device itself, but rather can include the one or more other devices that would, in those other embodiments, have such functionality/features.

A description of an embodiment with several components or features does not imply that any particular one of such components and/or features is required. On the contrary, a variety of optional components are described to illustrate the wide variety of possible embodiments of the present invention(s). Unless otherwise specified explicitly, no component and/or feature is essential or required.

Further, although process steps, algorithms or the like may be described or depicted in a sequential order, such processes may be configured to work in one or more different orders. In other words, any sequence or order of steps that may be explicitly described or depicted does not necessarily indicate a requirement that the steps be performed in that order. The steps of processes described in this disclosure may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications, does not imply that the illustrated process or any of its steps is necessary to the invention, and does not imply that the illustrated process is preferred.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

The present disclosure provides, to one of ordinary skill in the art, an enabling description of several embodiments and/or inventions. Some of these embodiments and/or inventions may not be claimed in the present application but may nevertheless be claimed in one or more continuing applications that claim the benefit of priority of the present application. Applicant reserves the right to file additional applications to pursue patents for subject matter that has been disclosed and enabled but not claimed in the present application.

What is claimed is:

1. An axe head for a throwing axe, the axe head comprising:
a blade having a concave forward edge, wherein the blade tapers to a tip for embedding in a target.

2. The axe head of claim 1, further comprising a second blade opposite the blade, the second blade having a second concave forward edge, wherein the second blade tapers to a second tip for embedding in a target.

3. The axe head of claim 1, further comprising a pick on the opposite side of the axe head from the tip.

4. A throwing axe comprising:
a blade having a single concave profile;
a beard;
a tapered tip configured to embed in a target; and
a handle attached to the blade.

5. The throwing axe of claim 4, further comprising:
a pick opposite the blade.

6. An axe head for a throwing axe, the axe head comprising:
a blade portion including a striking face having an upper axe tip portion and a lower axe tip portion, the striking face being substantially concavely arcuate between the upper axe tip portion and the lower axe tip portion.

7. The axe head of claim 6, further comprising a pick opposite the blade portion.

8. The axe head of claim 6, further comprising a beard, wherein the beard comprises the lower axe tip portion.

9. The axe head of claim 6, wherein the blade portion comprises at least one sharpened edge.

10. The axe head of claim 6, wherein the striking face comprises a sharpened edge.

11. The axe head of claim 6, wherein the angular concavity of the striking face is substantially uniform.

12. The axe head of claim 6, wherein the angular concavity of the striking face is not uniform.

13. The axe head of claim 6, wherein the axe head comprises a second striking face along a top surface of the axe head, the second striking face being substantially concavely arcuate.

14. The axe head of claim 6, further comprising an aft portion opposite the blade portion, the aft portion comprising one of the following:
a pick,
a second blade, and
a blunt surface.
